(19) United States
(12) Patent Application Publication
(10) Pub. No.: US 2018/0186667 A1
(43) Pub. Date: Jul. 5, 2018

(54) SUSTAINED SILVER RELEASE COMPOSITION FOR WATER PURIFICATION

(71) Applicant: INDIAN INSTITUTE OF TECHNOLOGY, Chennai (IN)

(72) Inventors: Thalappil Pradeep, Chennai (IN); Amrita Chaudhary, Varanasi (IN); Mohan Udhaya Sankar, Cuddalore (IN); Gayathri Rajarajan, Chennai (IN); Anshup, Lucknow (IN)

(21) Appl. No.: 15/677,618

(22) Filed: Aug. 15, 2017

Related U.S. Application Data
(63) Continuation of application No. 14/007,295, filed on Mar. 27, 2014, now abandoned.

(30) Foreign Application Priority Data
Mar. 25, 2011 (IN) 947/CHE/2011

(51) Int. Cl. C02F 1/50; C02F 1/28; B01J 20/32; B82Y 30/00; B01J 20/02; B01J 20/30; B01J 20/28; B01J 20/08; B01J 20/06; C02F 1/00

(52) U.S. Cl. CPC C02F 1/50; C02F 1/505; C02F 1/288; B01J 20/3204; B82Y 30/00; C02F 1/001; B01J 20/0233; B01J 20/3057; B01J 20/28007; B01J 20/08; B01J 20/06; B01J 20/3236

(57) ABSTRACT

Described herein are methods and compositions for preparing an adsorbent composition for sustained silver ion release is provided. The method comprises impregnating silver nanoparticles on an organic-templated-nanometal oxyhydroxide. Particle size of the silver nanoparticles is less than about 50 nm. The adsorbent composition is antimicrobial in water. In an aspect, the organic-templated-nanometal oxyhydroxide is organic-templated-boehmite nanoarchitecture (OTBN). The resultant adsorbent composition is used as a water filter in a water purification device.

### BACKGROUND

### Technical Field

The present disclosure relates to the field of water purification and specifically to compositions and methods related to sustained silver release for water purification.

### Technical Background

Contamination of drinking water is a major health concern across the world, especially in the developing and under-developed countries. A number of contaminants affect the water quality including biological (e.g. bacteria and virus), inorganic (e.g. fluoride, arsenic, iron) and organic (e.g. pesticides, volatile organics) species. These contaminants in water are a source of a number of diseases for a large population of the world. A significant cost burden associated with health effects of the contaminated water still rests on the shoulders of the poor. This problem can be addressed by developing affordable and effective solutions for removal of these contaminants.

Silver is widely known for its antibacterial property and has been employed as an inorganic silver salt, as an organic silver salt and as colloids of its salt, oxide, and in metallic states for treatment of contaminated water. Although it is well known that silver is a good antibacterial agent, the nature of silver present in the water determines its antibacterial efficiency. Recently, silver has been extensively used in the form of metallic nanoparticles. The antibacterial property of silver nanoparticles emerges either from nanoparticle-bacteria surface interaction or from released silver ions from nanoparticles or both.

Antibacterial property of silver nanoparticles has been discussed in a number of patent applications, wherein improvements to method of synthesis of silver nanoparticles have been disclosed (Pal et. al. in Appl Environ Microbiol., 2007, 73(6), 1712; De Windt et. al. in United States Patent Application 20100272770; Sastry et. al. in 936/MUM/2008), methods for their synthesis in media other than water have been used (Chen et. al. in U.S. Pat. No. 7,329,301), and methods for loading silver nanoparticles on various substrates have been discussed (Rautaray et. al. in Indian patent application 1571/MUM/2008). The enhanced antibacterial property of silver nanoparticles is due to size confinement of silver metal. Although a number of methods have been developed for the synthesis of silver nanoparticles, keeping reactive particles in nanometer size for a long time in real water composed of various species is very difficult. This is due to ion induced aggregation, surface modification, salt deposition and so forth. Therefore, an important requirement while employing reactive silver nanoparticles in water purification is size stabilization and preventing surface modification over extended periods.

Another important aspect of use of silver nanoparticles for anti-bacterial performance is the fraction of silver ions released (quantity of silver ions released/quantity of silver nanoparticle used). It is known that although significant quantities of silver nanoparticles are used, a small amount of silver ions are released into the contaminated water. For example, Hoek et al. (Environ. Sci. Technol. 2010, 44, 7321) reported that in reproduced real water having total dissolved solids (TDS) of around 340 parts per million (ppm), the fraction of dissolved silver is less than 0.1% of the total mass of silver added, regardless of the initial source, i.e., AgNO₃ or silver nanoparticles. This phenomenon is attributed to the presence of various anions in water, such as chlorides (many silver salts have very low solubility). Hence, the quantity of silver nanoparticles used in water filters is more than the optimum and results in an increase in the filter size and the cost of the device.

The release rate of silver ion from the nanoparticles determines how long the nanoparticles can be used as an antimicrobial agent. Constant release of silver ions from silver nanoparticles for longer time is essential for effective use in water filters. This ensures consistent anti-microbial performance and release of silver ions below permissible limit as prescribed by the World Health Organization (WHO). The rate of silver ion release has been discussed in the literature. For example, Epple et al. (Chem. Mater. 2010, 22, 4548 and Hurt et al. Environ. Sci. Technol. 2010, 44, 2169) demonstrated that the release of silver ions from silver nanoparticles in distilled water depends on temperature, incubation days, and species present in the water such as dissolved oxygen level, salt, and organic matter. The rate of dissolution is not constant with time and attains saturation in a short period.

Hence, stability of reactive nanoparticles for prolonged periods in water is essential for controlled release of silver ions. Metal oxides have been widely considered as good substrates. Silver nanoparticles have been ex-situ and in-situ loaded in/on metal oxides. In-situ loading in metal oxide has shown promising stability even at high loading percentage. For example, in-situ syntheses of silver nanoparticles in metal oxide matrices have been reported earlier. Chen et al. Environ. Sci. Technol. 2009, 43, 2905 demonstrated the sol-gel synthesis of silver nanoparticles (<5 nm) loaded onto TiO₂ nanocomposite where TiO₂ particles act as anti-aggregation support and showed that 7.4 wt % Ag loading in TiO₂ had highly potent antibacterial properties against E. coli. Similar results were obtained by the use of rice husk ash (Rautaray et. al. 1571/MUM/2008). Results obtained by this group indicates that the leached silver concentration varied in a wide range of 1.3 ppb-65 ppb (measured over a volume of 3000 L).

Various attempts have been made to synthesize silver nanoparticles on low-cost substrates. For example, Shankar et al. (J Chem Technol Biotechnol. 2008, 83, 1177) loaded silver on activated carbon at high silver loading percentage. An optimum of 9-10.5 wt % of Ag loaded in activated carbon (5 g) is necessary to have effective anti-bacterial properties against E. coli (concentration: 10³ CFU/ml) in the contact-mode for up to 350 L of flowing water (flow rate: 50 mL/min). Accordingly, ˜0.5 g of silver for 350 L of bacteria free water should be used which has a cost of 10 paise/liter (US$0.0088/gallon) water.

As described above, current systems fail to address the problem of stabilization of silver nanoparticles on a supporting matrix. Further, the surface chemistry is altered in controlled silver ion release systems over extended periods, thereby requiring the use of large quantities of silver. Controlled constant silver release determines the long term use, effectiveness, and the life time of a device and low cost.

The above referenced shortcomings are resolved by the compositions and methods described herein.

### SUMMARY

The compositions and methods described herein, in one aspect, relates to water purification. Particularly, the disclosure compositions and methods described herein relates to a sustained silver release composition for water purification.

An object of the compositions and methods described herein is to provide dissolution of silver ions from silver nanoparticles in water, for prolonged use (composition for a sustained silver ion release).

Another object of the compositions and methods described herein is to increase the volume of water that can be treated with silver nanoparticles while maintaining a substantially constant concentration of silver ions in the water derived from the silver nanoparticles. The silver nanoparticles can be loaded on organic polymer-metal oxide/hydroxide composite such as an organic-templated-boehmite nanoarchitecture (OTBN).

Yet another object of the compositions and methods described herein is to use organic polymer-metal oxide/hydroxide composites as a dual stabilizing agent for the synthesis of highly dispersed and stable silver nanoparticles. The silver nanoparticles can be antimicrobial, for example antibacterial, at a loading of about 0.1-1 wt %.

The compositions and methods described herein release at least 10% of the silver present in nanoparticles into the water with moderately high TDS from silver nanoparticles loaded OTBN over an extended period. An aspect of the compositions and methods described herein includes the volume of water treated and time independent constant release of silver ion from a Ag-OTBN matrix.

In one aspect, a method is disclosed for preparing an adsorbent composition. The method comprises impregnating silver nanoparticles on an organic-templated-nanometal oxyhydroxide. Particle size of the silver nanoparticles can be less than about 50 nm. The adsorbent composition has antimicrobial properties in water. In an aspect, the organic-templated-nanometal oxyhydroxide can be organic-templated-boehmite nanoarchitecture (OTBN).

In the compositions and methods described herein, the potent antibacterial material for long term use is obtained when silver nanoparticles are synthesized in organic-templated metal oxide/hydroxide nanoarchitecture. Stability of silver nanoparticles in water for longer time determines its antibacterial properties over time. Stable silver nanoparticles can be achieved via a in-situ syntheses of the nanoparticles in the OTBN matrix. Disclosed herein is an OTBN matrix that enhances the antimicrobial (i.e. antibacterial) property of silver nanoparticles in water. The matrix controls the size and stabilizes the particles from aggregation, and prevents the adsorption/deposition/scaling of soluble ligands, organic matters and dissolved solids on the silver nanoparticles.

The surface reactivity of silver nanoparticles can be maintained by both chitosan and metal oxide/hydroxide. Silver nanoparticles encapsulated by chitosan, can be dispersed in metal oxide support and vice-versa. The dual stabilization prevents the surface modification and also salt deposition over a period of time. This is further explained through the material characterization studies.

In one aspect, the compositions disclosed herein can contain 0.5 wt % Ag loaded in OTBN with antimicrobial properties. For example the compositions and methods can kill 10⁵ CFU/mL of E. coli in the contact-mode using several hundred liters, for example 100, 200, 300, 400, 500, 600 or 700 liters, of flowing water at very high flow rate. This is achieved through controlled constant release of silver ion for long time, for example 50 mL/min, 100 mL/min, 200 ml/min, 300 ml/min, 400 ml/min, 500 ml/min or 1000 ml/min.

In one aspect the silver nanoparticles described herein can kill 10⁵ CFU/mL of E. coli in tap water. In another aspect, killing microorganism with the disclosed compositions and methods does not require contact between the microorganisms and the nanoparticles.

In another aspect, a water purification device that includes a water filter is disclosed. The water filter can be made of an adsorbent composition prepared by impregnating silver nanoparticles on an organic-templated-nanometal oxyhydroxide, wherein a particle size of the silver nanoparticles is less than about 50 nm. The adsorbent composition can kill microorganisms, i.e have antimicrobial properties, in water. The water filter can be in the form of a candle, a molded porous block, a filter bed and a column. In another aspect, the water filter can be in the form of a sachet or porous bag.

Additional aspects and advantages of the invention will be set forth, in part, in the detailed description and any claims which follow, and in part will be derived from the detailed description or can be learned by practice of the invention. The advantages described below will be realized and attained by means of the elements and combinations particularly pointed out in the appended claims. It is to be understood that both the foregoing general description and the following detailed description are exemplary and explanatory only and are not restrictive of the invention as disclosed.

### BRIEF DESCRIPTION OF THE FIGURES

The accompanying figures, which are incorporated in and constitute a part of this specification, illustrate several aspects and together with the description serve to explain the principles of the invention.

FIG. 1 is a schematic representation of chemical reactions involved in the method for preparation of silver nanoparticles loaded organic-templated-boehmite nanoarchitecture (OTBN), in accordance with an embodiment of the present invention.

FIG. 2 depicts X-ray diffraction patterns of an organic-templated-boehmite nanoarchitecture (OTBN) and silver nanoparticles loaded OTBN, in accordance with various aspects of the present disclosure.

FIG. 3 depicts high-resolution transmission electron microscopic (HRTEM) micrographs of silver nanoparticles loaded OTBN system and an energy-dispersive X-ray (EDAX) spectrum of silver nanoparticles loaded OTBN, in accordance with various aspects of the present disclosure.

FIG. 4 depicts TEM-EDAX elemental imaging of silver nanoparticles loaded OTBN matrix, in accordance with various aspects of the present disclosure.

FIG. 5 depicts FESEM image of silver nanoparticles loaded OTBN, SEM image of granular composite and corresponding SEM-EDAX based elemental composition.

FIG. 6 depicts antibacterial activity of silver nanoparticles loaded OTBN tested in batch mode, in accordance with various aspects of the present disclosure.

FIG. 7 depicts antibacterial activity of silver nanoparticles loaded OTBN tested in column mode, in accordance with various aspects of the present disclosure.

FIG. 8 depicts inductively coupled plasma optical emission spectrometry (ICP-OES) data for silver ion leaching in E. coli contaminated water, in accordance with various aspects of the present disclosure.

FIG. 9 depicts antiviral activity of silver nanoparticles loaded OTBN tested in batch mode, in accordance with various aspects of the present disclosure.

### DESCRIPTION

The present invention can be understood more readily by reference to the following detailed description of the invention and the examples included therein.

Before the present compounds, compositions, articles, systems, devices, and/or methods are disclosed and described, it is to be understood that they are not limited to specific synthetic methods unless otherwise specified, or to particular reagents unless otherwise specified, as such can, of course, vary. It is also to be understood that the terminology used herein is for the purpose of describing particular aspects only and is not intended to be limiting. Although any methods and materials similar or equivalent to those described herein can be used in the practice or testing of the present invention, example methods and materials are now described.

All publications mentioned herein are incorporated by reference to disclose and describe the methods and/or materials in connection with which the publications are cited.

### Definitions

Unless defined otherwise, all technical and scientific terms used herein have the same meaning as commonly understood by one of ordinary skill in the art to which this invention belongs. Although any methods and materials similar or equivalent to those described herein can be used in the practice or testing of the present invention, example methods and materials are now described.

As used in the specification and the appended claims, the singular forms “a,” “an” and “the” include plural referents unless the context clearly dictates otherwise. Thus, for example, reference to “a metal” includes mixtures of two or more metals.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “optional” or “optionally” means that the subsequently described event or circumstance can or cannot occur, and that the description includes instances where said event or circumstance occurs and instances where it does not.

Disclosed are the components to be used to prepare the compositions of the invention as well as the compositions themselves to be used within the methods disclosed herein. These and other materials are disclosed herein, and it is understood that when combinations, subsets, interactions, groups, etc. of these materials are disclosed that while specific reference of each various individual and collective combinations and permutation of these compounds cannot be explicitly disclosed, each is specifically contemplated and described herein. For example, if a particular compound is disclosed and discussed and a number of modifications that can be made to a number of molecules including the compounds are discussed, specifically contemplated is each and every combination and permutation of the compound and the modifications that are possible unless specifically indicated to the contrary. Thus, if a class of molecules A, B, and C are disclosed as well as a class of molecules D, E, and F and an example of a combination molecule, A-D is disclosed, then even if each is not individually recited each is individually and collectively contemplated meaning combinations, A-E, A-F, B-D, B-E, B-F, C-D, C-E, and C-F are considered disclosed. Likewise, any subset or combination of these is also disclosed. Thus, for example, the sub-group of A-E, B-F, and C-E would be considered disclosed. This concept applies to all aspects of this application including, but not limited to, steps in methods of making and using the compositions of the invention. Thus, if there are a variety of additional steps that can be performed it is understood that each of these additional steps can be performed with any specific embodiment or combination of embodiments of the methods of the invention.

Each of the materials disclosed herein is either commercially available and/or the methods for the production thereof are known to those of skill in the art.

It is understood that the compositions disclosed herein have certain functions. Disclosed herein are certain structural requirements for performing the disclosed functions and it is understood that there are a variety of structures that can perform the same function that are related to the disclosed structures, and that these structures will typically achieve the same result.

In one aspect, synthesis, characterization and application of silver nanoparticles impregnated organic-templated-boehmite-nanoarchitecture (Ag-OTBN) are described. Impregnation of silver nanoparticles in OTBN is demonstrated using a number of procedures. The as-synthesized Ag-OTBN composition is characterized by a number of spectroscopic and microscopic techniques. The capability of Ag-OTBN to remove microorganisms from drinking water is demonstrated through the use of E. coli and MS2 bacteriophage as model organisms for bacteria and virus, respectively.

The silver nanoparticles can be impregnated in p-block, transition and rare-earth metal doped organic template metal oxyhydroxide compositions. It should also be noted that it can be of mixed metal oxide/hydroxide/oxyhydroxide nanoarchitecture. The mixture can be binary or a mixture of all the above mentioned metal oxide/hydroxide/oxyhydroxide.

In an aspect, the Ag-OTBN defined in the present invention can have chitosan polymer to metal oxide/hydroxide weight ratio between 5% and 50%. In another aspect, Ag to OTBN weight ratio can be between 0.1 to 10%.

In another aspect, the silver nanoparticles can be synthesized in OTBN using any reducing agent at any temperature for any application. In one aspect, the reducing agent can be ascorbic acid, tri sodium citrate, dextrose, hydrazine, etc., and at a temperature between 40 to 200° C.

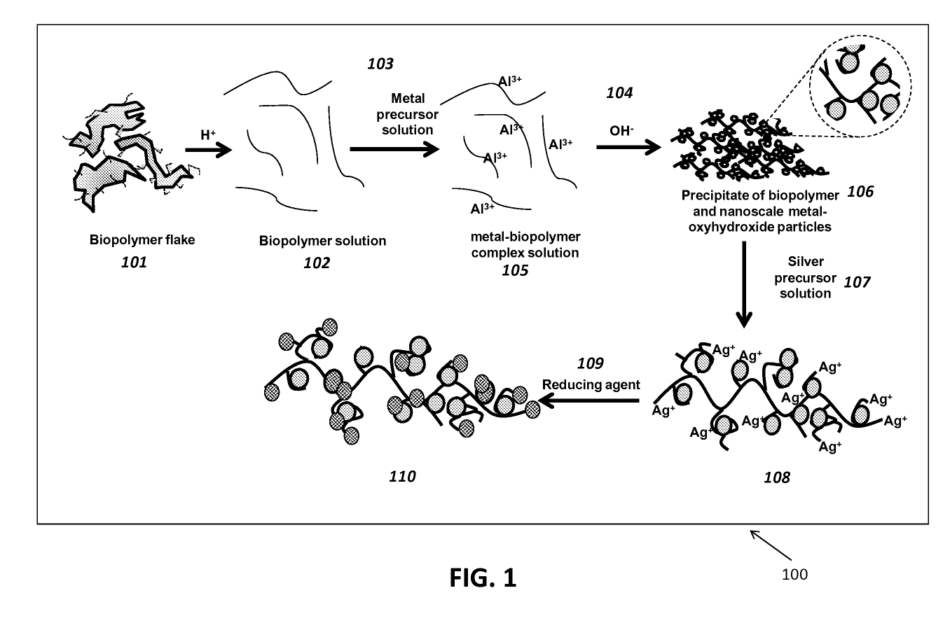

FIG. 1 illustrates the scheme 100 utilized for the preparation of granular composite of silver nanoparticles loaded metal oxyhydroxide particles-biopolymer. Steps 101-106 have been described in the PCT application PCT/IB2011/001551 by Pradeep et al.\, its entire contents of which is hereby incorporated by reference. The filtered composite gel 106 is thereafter homogeneously dispersed in distilled water. Silver precursor solution 107 is then added to metal oxyhydroxide particles-biopolymer composite 106. Metal oxyhydroxide particles-biopolymer composite 106 and silver ions of silver precursor solution 107 interact with each other through a number of functional groups to obtain silver ion complexed metal oxyhydroxide particles-biopolymer composite 108. Further, reducing agent 109 is added to 108. Upon addition of reducing agent 109, silver particles in the precursor solution 107 undergo reduction and nucleate on metal oxyhydroxide particles-biopolymer composite 108 to form silver nanoparticles loaded metal oxyhydroxide particles-biopolymer composite. Eventually, a semi solid precipitate 110 is obtained, which is washed with copious amounts of water and is dried at a temperature between 30-60° C.

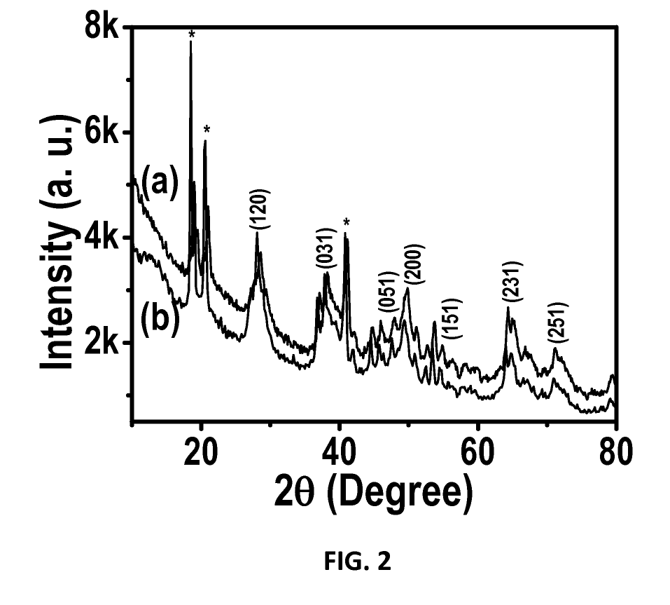

FIG. 2 shows X-ray diffraction patterns of an organic-templated-boehmite nanoarchitecture (OTBN) and silver nanoparticles loaded OTBN are shown, in accordance with various aspects of the present disclosure. In FIG. 2, the peaks marked by * correspond to the organic template i.e., chitosan.

The as-synthesized OTBN shows peaks corresponding to (120), (013), (051), (151), (200), (231) and (251) planes (refer to curve (a)). These peaks can be indexed as orthorhombic-AlOOH (JCPDS 21-1307). The broadened XRD peaks imply that the crystallite size of OTBN particles is very small. The mean crystallite size calculated from the Scherrer formula shows that nanocrystals have an average size of 3.5 nm. The presence of organic template (i.e., chitosan) can also been seen in the XRD data. The peaks marked by * in FIG. 2 corresponding to 20 (in degrees)=18.7°, 20.6°, and 41.2° are attributed to the presence of the organic template. It is clear that there is a definite difference in the full-width at half maxima (FWHM) for the peaks corresponding to AlOOH and organic template.

Upon impregnation of silver nanoparticles in the OTBN, there are no new peaks observed in the diffraction pattern (refer to curve (b)). This is attributed to the low loading percentage of silver nanoparticles and homogeneous distribution of silver nanoparticles in OTBN. Comparing the diffraction peaks of OTBN and silver nanoparticles impregnated OTBN, a negative shift in the 20 value is observed. The interplanar distance of OTBN increases after loading of silver nanoparticles. This is a clear evidence of the loading of an external material which increases the interplanar spacing.

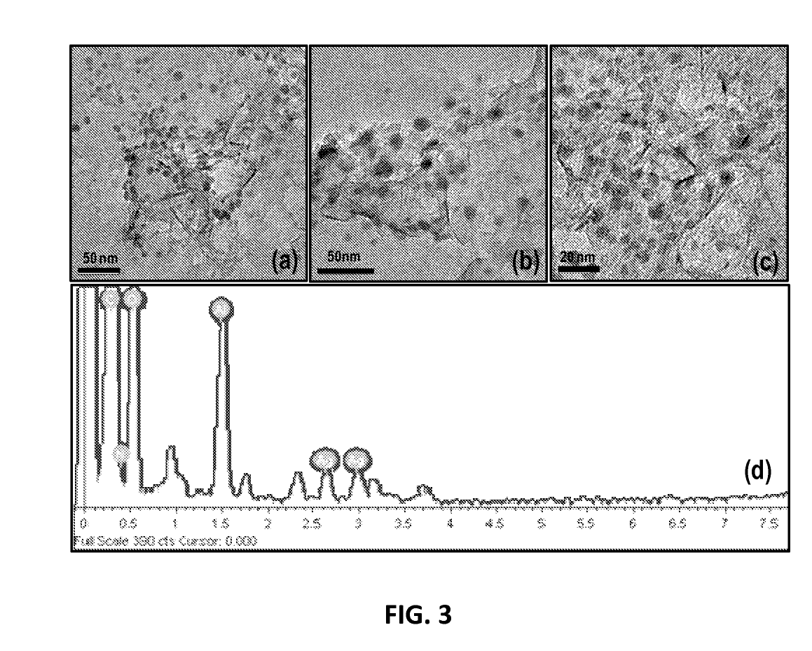

FIG. 3 shows high-resolution transmission electron microscopic (HRTEM) micrographs of silver nanoparticles loaded OTBN system and an energy-dispersive X-ray (EDAX) spectrum of silver nanoparticles loaded OTBN, in accordance with various aspects of the present disclosure. FIG. 3(a) to 3(c) show HRTEM micrographs of Ag nanoparticles loaded OTBN system and spectrum 3(d) shows the EDAX spectrum of Ag nanoparticles loaded OTBN.

In order to determine the interaction between OTBN and silver nanoparticles, silver nanoparticles impregnated OTBN matrix was analyzed under transmission electron microscope. The TEM image shows the three components i.e., silver nanoparticles, organic polymers and metal oxide/hydroxide nanoparticles in the Ag-OTBN. The OTBN matrix stabilizes the silver nanoparticles from aggregation, which results in the homogenous distribution of silver nanoparticles in the matrix. It is clear from the TEM images that homogenously sized silver nanoparticles are anchored in the organic polymer-metal oxide/hydroxide nanoparticle matrix (pictures (b) and (c)) and the silver nanoparticles are of 5-10 nm in size (picture (c)). The sheet-like organic polymer chitosan is seen clearly (FIGS. 3 (a), (b) and (c)). Such homogeneity is difficult in unprotected silver nanoparticles. Typically, homogeneity is brought about by monolayer protection.

This HRTEM of the composition also shows that silver nanoparticles are trapped in the biopolymer-metal oxyhydroxide cages. This allows nanoparticles to be preserved by reducing contact with the scale forming chemical species while allowing sufficient interaction with water, which results in sustained release of Ag⁺ions.

Graph (d) shows the EDAX spectrum measured from the area shown in picture (b). From this, the presence of silver is confirmed.

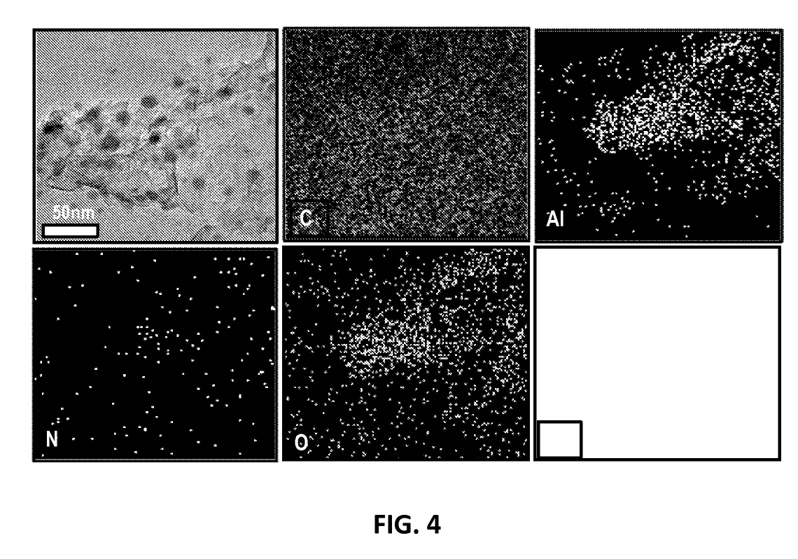

FIG. 4 shows EDAX elemental imaging of silver nanoparticles loaded OTBN matrix, in accordance with various aspects of the present disclosure. In FIG. 4, the top left extreme is the TEM image and others are elemental maps from the region.

EDAX coupled with TEM was used to image the elemental mapping of Ag loaded OTBN. Elements present in the Ag-OTBN such as C, N, O, Al and Ag were mapped. The presence of three components i.e., chitosan (C, N and O), boehmite (Al and O) and silver nanoparticles (Ag) was confirmed.

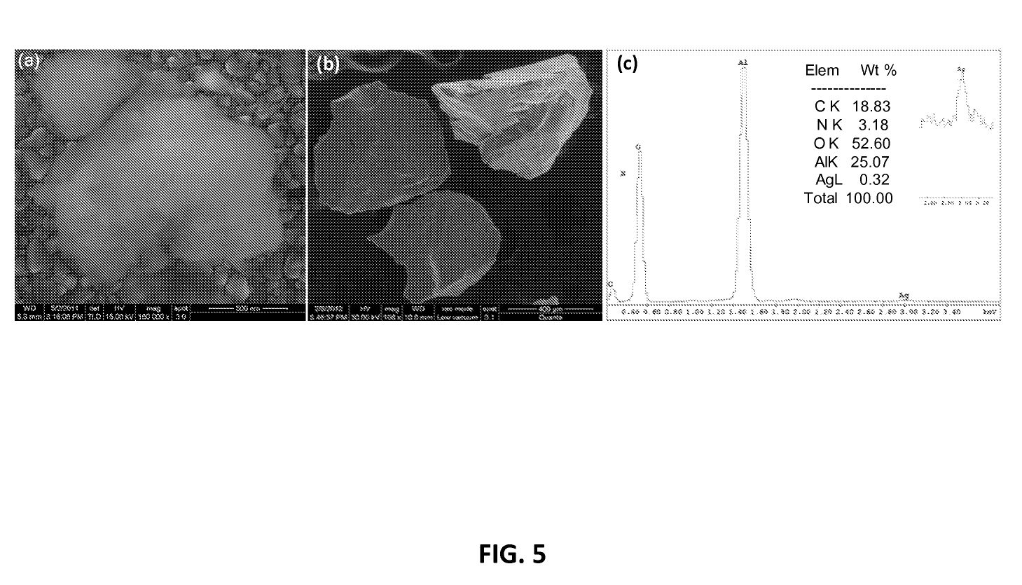

FIG. 5 shows the SEM micrograph of silver nanoparticles loaded OTBN and its chemical composition. Silver nanoparticles are not visible on the surface of the composition (note: particles of similar size (10-30 nm) from substrate (Indium tin oxide) are clearly observable in the highlighted red circle) (FIG. 5(a)). This confirms that silver nanoparticles are embedded and well-protected in the OTBN matrix. Granular form of the composition is also visible (FIG. 5(b)). Elemental composition confirms the presence of essential elements: carbon, nitrogen, oxygen, aluminum and silver (FIG. 5(c)). Insets show the elemental composition for an illustrative silver nanoparticles impregnated OTBN and expanded region of EDAX spectrum around 3 keV, confirming the presence of silver (note: carbon content is higher due to presence of conducting carbon tape in the background).

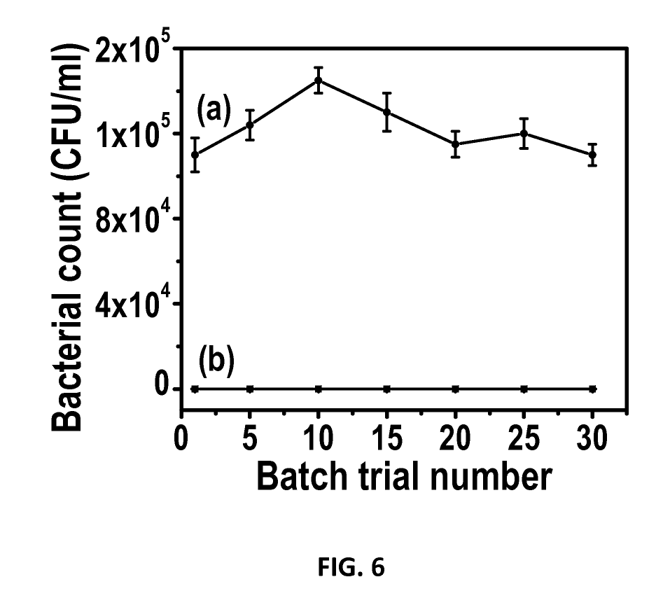

FIG. 6 shows an antibacterial activity of silver nanoparticles loaded OTBN tested in batch mode, in accordance with various aspects of the present disclosure. In FIG. 6 curve (a) depicts the input E. coli concentration and curve (b) depicts the output E. coli concentration.

The Ag-OTBN material as explained in example 1 was used for batch study. As explained in the example 7, the antibacterial activity was tested for batch mode. FIG. 6 shows the antibacterial efficiency of Ag-OTBN with number of trials. Curve (a) in shows the input concentration of E. coli and curve (b) shows the number of E. coli colonies after 1 hour of shaking. It is confirmed from curve (b) that the Ag-OTBN completely kills the E. coli present in the water. For up to 30 trials, complete killing of E. coli was seen. It should be noted that the number of trials or the output E. coli counts do not indicate the saturation point of the Ag-OTBN material, but show the continuous release of silver ions at constant rate. It should also be noted that the concentration of released silver ions from silver nanoparticles is higher under shaking for an hour. The antibacterial activity of Ag-OTBN in batch mode indirectly demonstrates the promising long-time antibacterial activity of Ag-OTBN in column mode.

The material was also tested for antibacterial study without contact mode. The 100 mL of the shaken water was filtered and 1×10⁵ CFU/mL of bacterial load was added to the water. It was plated as described in the foregoing specification. The performance of the material tested without contact mode is similar to the material tested with contact mode (data not shown). It showed that the antibacterial property is due to the released silver ions from silver nanoparticles.

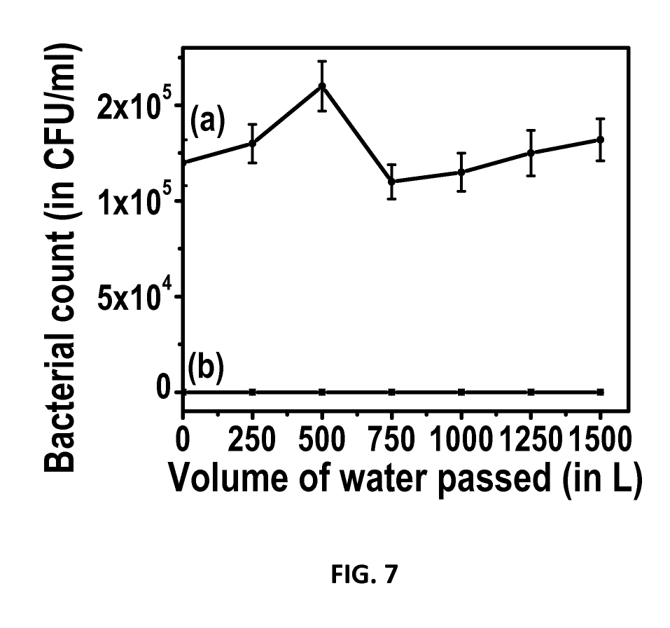

FIG. 7 depicts an antibacterial activity of silver nanoparticles loaded OTBN tested in column mode, in accordance with various aspects of the present disclosure. In FIG. 7, curve (a) depicts the input E. coli concentration and curve (b) depicts the output E. coli concentration. As explained in the example 8, the antibacterial activity was tested for a column filled with Ag-OTBN. FIG. 7 shows the antibacterial efficiency of Ag-OTBN with volume of contaminated water passed. Curve (a) in FIG. 6 shows the input concentration of 10⁵ CFU/mL E. coli and curve (b) shows the number of surviving E. coli colonies after filtration. Curve (b) shows that the Ag-OTBN material kills E. coli for 1500 L at 1000 mL/min flow rate. It should be noted that complete killing was observed at 10 mL/min, 100 mL/min and 1000 mL/min flow rate, separately. Hence, the present invention demonstrates that the complete killing of E. coli at the concentration of ˜10⁵ CFU/mL can be achieved using Ag-OTBN material even at very high flow rate such as ˜1000 mL/min.

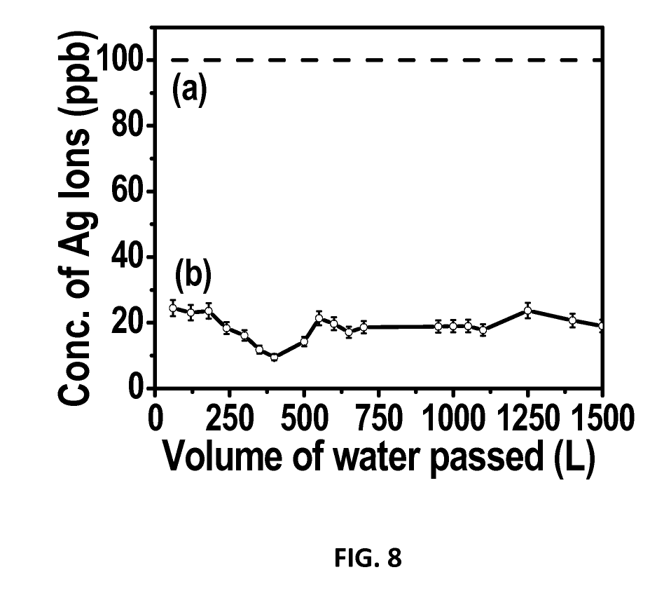

FIG. 8 depicts inductively coupled plasma optical emission spectrometer (ICP-OES) data for silver ion leaching in E. coli contaminated water, in accordance with various aspects of the present disclosure. In FIG. 8, curve (a) shows the allowed silver ion concentration in drinking water as per WHO norms and curve (b) shows the released silver ion concentration in output water, in accordance with an aspect of the present invention.

The Ag-OTBN material as explained in example 1 was used for column study. As explained in the example 8, the antibacterial activity was tested for Ag-OTBN in column mode. E. coli concentration of 1×10⁵ CFU/mL was periodically spiked in challenge water at the passage of 0, 250, 500, 750, 1000, 1250 and 1500 L. Contaminated water was passed at a flow rate of 10-2000 mL/min, preferably at 1000 mL/min. At regular intervals, the microbial de-contaminated output water was collected. Quantitative detection of concentration of silver ions released from the Ag-OTBN material was performed using Inductively Coupled Plasma Optical Emission Spectrometer (ICP-OES). FIG. 8 shows the relation between the concentration of silver ions released into the contaminated challenge water and the volume of water passed. Curve (a) in FIG. 8 shows the allowed silver ion concentration in drinking water and curve (b) shows the released silver ion concentration from Ag-OTBN. FIG. 8 shows that silver ions are continuously released into the contaminated challenge water at a constant rate and the concentration found was significantly below the permitted level of silver ions in drinking water. The present invention demonstrates that the silver ions released from Ag-OTBN into the challenge water are enough for killing all E. coli present in the water. From the ICP-OES, it was found that more than 10% of silver from Ag-OTBN released into water upon passage of 1500 L of challenge water.

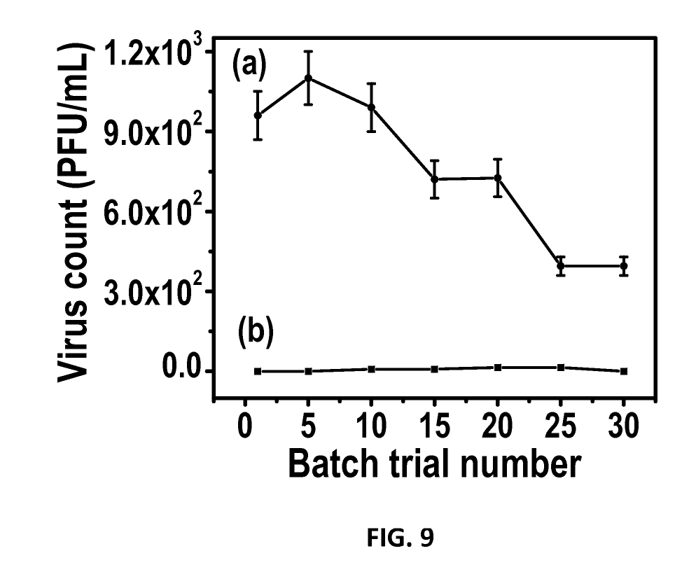

FIG. 9 shows an antiviral activity of silver nanoparticles loaded OTBN tested in batch mode, in accordance with various aspects of the present disclosure. In FIG. 9, curve (a) depicts the input MS2 coliphage concentration and curve (b) depicts the output MS2 coliphage concentration. The Ag-OTBN material as explained in example 1 was used for batch study and the antiviral activity was tested as explained in the example 9. FIG. 9 shows the antiviral efficiency of Ag-OTBN with number of trials. Curve (a) in FIG. 8 shows the input concentration of MS2 coliphage and curve (b) shows the number of MS2 coliphage plaques after 1 hour of shaking. It is confirmed from curve (b) that the MS2 coliphage is completely removed from the water. For up to 35 trials, complete removal of MS2 coliphage was observed. It should be noted that the number of trials or the output counts do not indicate the saturation point of the Ag-OTBN material, but show the continuous performance of its antiviral property. Antiviral activity of Ag-OTBN in batch mode indirectly demonstrates the promising long-time performance of Ag-OTBN in column mode.

In an aspect of the present invention, a method for preparing an antimicrobial composition for water purification is provided. Silver nanoparticles are impregnated on an organic-templated-nanometal oxyhydroxide, such as OTBN. The particle size of the silver nanoparticles is preferably less than about 50 nm. Sizes include, but are not limited to, less than 50 nm, 40 nm, 30 nm, 20 nm, 10 nm, and 5 nm. The antimicrobial composition is used for killing microorganisms in water as explained in the foregoing specification. The silver ions are impregnated with OTBN in gel or solid states. The method also includes reduction of the silver ions to a zerovalent state by using a reducing agent, such as sodium borohydride, ascorbic acid, tri-sodium citrate, hydrazine hydrate or combinations thereof. In an aspect, the concentration of the reducing agent is kept in the range of about 0.001 M to about 1 M. In a preferred aspect, the concentration of the reducing agent is kept at 0.001 M to 0.05 M. Further, organic templates such as chitosan, banana silk and cellulose can be used. The invention supports following precursors: silver nitrate, silver fluoride, silver acetate, silver sulfate, silver nitrite and combinations thereof.

In one aspect, the compositions and methods release for silver ion into water for a prolonged period of time. For example, the compositions and methods can release a silver ions at a constant or substantially constant rate for at least 1 day, 1 week, 1 month, 3 months, 6 months, 1 year or 3 years.

In another aspect, a water purification system that includes a filter prepared by the method described herein is provided. The filter can be realized in the form of a candle, a molded porous block, a filter bed and a column. In another aspect, a water purification system can comprise the compositions described herein, for example, a silver impregnated boehmite structure, disposed in a sachet or porous bag, such that the sachet can be placed in contaminated water and the water allowed to flow through the sachet to contact the composition. A skilled artisan will appreciate that such forms of filters are well known in the art and their description has been omitted so as not to obfuscate the present disclosure.

The described aspects are illustrative of the compositions and methods and are not restrictive. Modifications of design, methods, structure, sequence, materials and the like that are apparent to those skilled in the art, also fall within the scope of the compositions and methods described herein.

### EXAMPLES

### Experimental Methods

### Material Characterization

The identification of the phase(s) of the as-prepared sample was carried out by X-ray powder diffraction (using D8 Discover of Bruker AXS, USA) using Cu-Kα radiation at λ=1.5418 Å. Surface examination was carried out using Field Emission Scanning Electron Microscope (using FEI Nova NanoSEM 600 instrument). For this, the sample was re-suspended in water by sonication for 10 minutes and drop-casted on an indium tin oxide (ITO) conducting glass. The sample was subsequently dried. Surface morphology, elemental analysis and elemental mapping studies were carried out using a Scanning Electron Microscope (SEM) equipped with Energy Dispersive Analysis of X-rays (EDAX) (using FEI Quanta 200 scanning electron microscope). Granular composition was imaged by attaching it on a conducting carbon tape. High resolution Transmission Electron Microscopy (HRTEM) images of the sample were obtained with JEM 3010 (JEOL, Japan). The samples prepared as above were spotted on amorphous carbon films supported on copper grids and dried at room temperature. X-ray Photoelectron Spectroscopic (XPS) analysis was performed using ESCA Probe TPD of Omicron Nanotechnology. Polychromatic Mg Kα was used as the X-ray source (hv=1253.6 eV). Spectra in the required binding energy range were collected and an average was taken. Beam induced damage of the sample was reduced by adjusting the X-ray flux. Binding energy was calibrated with respect to C 1s at 284.5 eV. Silver ion concentration in the water was detected using inductively coupled plasma optical emission spectrometry (ICP-OES).

The following are a few examples that illustrate the methods and compositions described herein. The examples should not be construed as limiting the scope of the methods and compositions described herein.

### Example 1

This example describes the in-situ impregnation of silver nanoparticles on OTBN. In an aspect, OTBN was prepared as reported in the previous Indian patent application 1529/CHE/2010, entire contents of which are herein incorporated by reference. The OTBN gel obtained after washing the salt content was used for the formation of silver nanoparticles. The OTBN gel was again re-dispersed in water, to which 1 mM silver precursor (silver nitrate, silver fluoride, silver acetate, silver permanganate, silver sulfate, silver nitrite, silver bromate, silver salicylate or any combination of the above) was added drop-wise. The weight ratio of Ag to OTBN can be varied anywhere between 0.1-1.5%. After stirring the solution overnight, 10 mM sodium borohydride was added to the solution drop wise (in ice-cold condition, temperature <5° C.). Thereafter, the solution was allowed to stir for half an hour, filtered and washed with copious amount of water. The obtained gel was then dried at room temperature.

### Example 2

This example describes the in-situ impregnation of silver nanoparticles on OTBN powder. In an aspect, the dried OTBN powder was crushed to a particle size of 100-150 micron. The powder was stirred in water, using an appropriate shaker. 1 mM silver precursor solution was then slowly added. The weight ratio of Ag to OTBN can be varied anywhere between 0.1-1.5%. After stirring the mixture overnight, 10 mM sodium borohydride was added to the mixture drop-wise (in ice-cold condition, temperature <5° C.). Thereafter, the mixture was allowed to stir for half an hour, filtered and washed with copious amount of water. The obtained powder is then dried at room temperature.

### Example 3

This example describes the ex-situ impregnation of silver nanoparticles on OTBN. In an aspect, the OTBN gel obtained after washing the salt content was used for the impregnation of silver nanoparticles. The OTBN gel was again re-dispersed in water, to which 1 mM silver nanoparticles solution (prepared by any route reported in the literature) was added drop-wise. The weight ratio of Ag to OTBN can be varied anywhere between 0.1-1.5%. After stirring the solution overnight, it was filtered and washed with copious amount of water. The obtained gel is then dried at room temperature.

### Example 4

This example describes the ex-situ impregnation of silver nanoparticles on OTBN powder. In an aspect, the dried OTBN powder was crushed to a particle size of 100-150 μm. The powder was stirred in water, using a shaker. 1 mM silver nanoparticles solution (prepared by any route reported in the literature) was added drop-wise. The weight ratio of Ag to OTBN can be varied anywhere between 0.1-1.5%. After stirring the solution overnight, it was filtered and washed with copious amount of water. The obtained powder was then dried at room temperature.

### Example 5

The organic templated metal oxyhydroxide/oxide/hydroxide matrix defined in the methods and compositions described herein. is such that the metal is chosen from amongst p-block, transition and rare-earth metal series. The metal precursor can be Fe(II), Fe(III), Al(III), Si(IV), Ti(IV), Ce(IV), Zn(II), La(III), Mn(II), Mn(III), Mn(IV), Cu(II) or a combination thereof. And the metal oxide/hydroxide/oxyhydroxide nanoparticle may serve as an inert filler material or an active filtration medium.

This example describes the silver nanoparticles impregnation in p-block, transition and rare-earth metal doped organic templated metal oxyhydroxide composition (as disclosed in the previous Indian patent application 1529/CHE/2010, entire contents of which are herein incorporated by reference). P-block, transition and rare-earth metals were chosen from the following: aluminum, manganese, iron, titanium, zinc, zirconium, lanthanum, cerium, silicon. The synthesis procedure for composition is as follows: the chosen metal (eg: La) salt was mixed with the ferric nitrate salt solution in an appropriate ratio, preferably 1:9 (wt/wt). The salt solution was added slowly to the chitosan solution (dissolved in 1-5% glacial acetic acid or HCl or combination thereof) with vigorous stirring for 60 minutes and was kept overnight. Aqueous ammonia or NaOH solution was slowly added into the La—Fe-chitosan solution with vigorous stirring to facilitate the precipitation of the metal-chitosan composites. Stirring was continued for two hours. The precipitate was filtered, washed to remove any unwanted impurities and dried.

The as-synthesized precipitate gel was again re-dispersed in water, to which 1 mM silver precursor was added drop-wise. The weight ratio of Ag to OTBN can be varied anywhere between 0.1-1.5%. After stirring the solution overnight, 10 mM sodium borohydride was added to the solution drop-wise (in ice-cold condition). Thereafter, the solution was allowed to stir for half an hour, filtered and washed with copious amount of water. The obtained gel was then dried at room temperature.

### Example 6

This example describes the doping of p-block, transition and rare-earth metal precursor in the composition. The procedure is similar to that described in example 5, with a change that gel or dried powder obtained after silver nanoparticles impregnation is soaked with metal precursor chosen from p-block, transition and rare-earth metal series.

### Example 7

This example describes the testing protocol in batch for antibacterial activity of silver nanoparticles impregnated OTBN composition. In an aspect, 100 mL of water was shaken with the material and 1×10⁵ CFU/mL of bacterial load was added to the water. Challenge water having the specific ions concentration similar to prescribed by US NSF for contaminant removal claim was used in the study. After one hour of shaking, 1 mL of the sample along with nutrient agar was plated on sterile petridish using the pour plate method. After 48 hours of incubation at 37° C., the colonies were counted and recorded. This procedure was repeated 25 to 30 times.

### Example 8

This example describes the testing protocol for antibacterial activity of silver nanoparticles impregnated OTBN powder packed in a column. In an aspect, the column in which a known quantity of the material is packed has a diameter between about 35 mm to about 55 mm. The feed water was passed at a flow rate in the range of 10 mL/min to 2000 mL/min. The challenge water was periodically subjected to an E. coli load of 1×10⁵ CFU/mL. The output water collected from the column was screened for bacterial presence by pour plate method. The bacterial colonies were counted and recorded after 48 hours of incubation at 37° C.

### Example 9

This example describes the testing protocol in batch for antiviral activity of silver nanoparticles impregnated OTBN composition. In an aspect, 100 mL of water was shaken with the material and 1×10³ PFU/mL of MS2 coliphage load was added to the water. The challenge water having specific ions concentration similar to prescribed by US NSF for contaminant removal claim was used in the study. After one hour of shaking, virus count was obtained by plaque assay method. After 24 hours of incubation at 37° C., the plaques were counted and recorded. This procedure was repeated for 35 to 40 times.

What is claimed is:

1. A method for preparing an adsorbent composition, the method comprising:
impregnating silver nanoparticles on an organic-templated-nanometal oxyhydroxide, wherein the adsorbent composition kills microorganisms in water by sustained and continuous silver ion release.

2. The method according to claim 1, wherein the organic-templated-nanometal oxyhydroxide is organic-templated-boehmite nanoarchitecture (OTBN).

3. The method of claim 2, wherein silver ions are impregnated with OTBN in a gel state.

4. The method of claim 3, further comprising reducing the silver ions to a zerovalent state by using a reducing agent.

5. The method of claim 4, wherein the reducing agent comprises sodium borohydride, ascorbic acid, tri-sodium citrate or hydrazine hydrate or mixtures thereof.

6. The method of claim 4, wherein the concentration of the reducing agent is about 0.001 M to about 1 M.

7. The method of claim 2, wherein silver ions are impregnated with OTBN in a solid state.

8. The method of claim 2, wherein externally prepared silver nanoparticles are impregnated in OTBN in at least one of a gel state and a solid state.

9. The method of claim 2, wherein impregnating the silver ions or silver nanoparticles comprises drop-wise adding silver ions or silver nanoparticles to the OTBN.

10. The method of claim 2, further comprising soaking the adsorbent composition.

11. The method of claim 1, further comprising soaking the adsorbent composition for about 30 minutes to 12 hours and preferably for a period of 1 hour.

12. The method of claim 1, wherein the organic template comprises chitosan, banana silk or cellulose, or mixtures thereof.

13. The method of claim 1 further comprising using a silver precursor for preparing the silver nanoparticles.

14. The method of claim 13, wherein the silver precursor comprises silver nitrate, silver fluoride, silver acetate, silver sulfate or silver nitrite, or mixtures thereof.

15. The method of claim 1, wherein the concentration of silver is about 0.001 M to about 1 M.

16. The method of claim 1, wherein the adsorbent composition is used for sustained and continuous release of silver into water below 100 parts per billion (ppb).

17. The method of claim 1, wherein the particle size of the silver particles is about 3 nm to about 10 μm.

18. A water purification device comprising a water filter, wherein the water filter is made of an adsorbent composition prepared by impregnating silver nanoparticles on an organic-templated-nanometal oxyhydroxide, and wherein the adsorbent composition kills microorganisms in water by sustained and continuous silver ion release.

19. The water purification device of claim 18, wherein the water filter is one of a candle, a molded porous block, a filter bed and a column.

20. The water purification device of claim 18, wherein the organic-templated-nanometal oxyhydroxide is organic-templated-boehmite nanoarchitecture (OTBN).

21. The water purification device of claim 18, wherein silver ions are impregnated with OTBN in a gel state.

22. The water purification device of claim 21, wherein the silver ions are reduced to a zerovalent state by using a reducing agent.

23. The water purification device of claim 22, wherein the reducing agent comprises sodium borohydride, ascorbic acid, tri-sodium citrate or hydrazine hydrate, or mixtures thereof.

24. The water purification device of claim 23, wherein the concentration of the reducing agent is about 0.001 M to about 1 M.

25. The water purification device of claim 20, wherein silver ions are impregnated with OTBN in a solid state.

26. The water purification device of claim 20, wherein externally prepared silver nanoparticles are impregnated in OTBN in at least one of a gel state and a solid state.

27. The water purification device of claim 20, wherein impregnating the silver ions or silver nanoparticles comprises drop-wise adding silver ions or silver nanoparticles to the OTBN.

28. The water purification device of claim 18, wherein the adsorbent composition is soaked for about 30 minutes to 12 hours and preferably for a period of one hour.

29. The water purification device of claim 18, wherein the organic template comprises chitosan, banana silk or cellulose, or mixtures thereof.

30. The water purification device of claim 18, wherein a silver precursor is used for preparing the silver nanoparticles.

31. The water purification device of claim 30, wherein the silver precursor comprises silver nitrate, silver fluoride, silver acetate, silver sulfate or silver nitrite, or mixtures thereof.

32. The water purification device of claim 18, wherein the concentration of silver is about 0.001 M to about 1 M.

33. The water purification device of claim 18, wherein the adsorbent composition continuously release silver into water below 100 parts per billion (ppb) for a prolonged period of time.

34. The water purification device of claim 18, wherein the particle size of the silver particles is about 3 nm to about 10 μm.
